(19) United States
(12) Patent Application Publication
(10) Pub. No.: US 2025/0125918 A1
(43) Pub. Date: Apr. 17, 2025

(54) USING COUNTER SPACE AND STOP BITS FOR DATA TRANSMISSION

(71) Applicant: Nokia Technologies Oy, Espoo (FI)

(72) Inventors: Wolfgang ZIRWAS, Munich (DE); Rakash SIVASIVA GANESAN, Unterhaching (DE); Berthold PANZNER, Holzkirchen (DE)

(73) Assignee: Nokia Technologies Oy, Espoo (FI)

(21) Appl. No.: 18/834,361

(22) PCT Filed: Feb. 10, 2022
(86) PCT No.: PCT/EP2022/053268

§ 371 Date: Jul. 30, 2024

(51) Int. Cl. H04L 5/00

(52) U.S. Cl. CPC H04L 5/0044; H04L 5/0007; H04L 5/0039; H04L 5/0094

(57) ABSTRACT

Solutions using a counter space and STOP bits to transmit data are disclosed. The counter space is a portion of a resource grid having a predetermined size in the time domain and in the frequency domain, wherein counter values are associated with respective resource elements of the counter space according to a predetermined rule. By means of the counter space and counter values, it is possible to transmit M binary string values of M binary strings of a predetermined length N by encoding STOP bits over respective resource elements of the counter space, and transmitting the encoded STOP bits. At a receiving side, the encoded STOP bits are decoded to M binary string values to obtain M binary strings of the predetermined length N.

### TECHNICAL FIELD

Various example embodiments relate to wireless communications.

### BACKGROUND

Wireless communication systems are under constant development. Use cases range from enhanced mobile broadband and ultra-reliable and low latency communications to massive machine-type communications, having in-between use cases, such as sensor networks, or video surveillance, with different requirements to resource usage, depending for example on the amount of data to be transmitted and how often there is data to be transmitted.

### BRIEF DESCRIPTION

The subject matter of the independent claims defines the scope.

According to an aspect there is provided an apparatus comprising at least one processor; and at least one memory including computer program code, the at least one memory and computer program code being configured to, with the at least one processor, cause the apparatus at least to: obtain M binary string values of M binary strings of a predetermined length N, M and N being two non-null positive integers; encode STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to the M binary string values; and transmit the encoded STOP bits.

In an embodiment, the counter space is pre-allocated to the apparatus, or configured to the apparatus via one or more configuration messages, or broadcast or scheduled for the apparatus for transmission.

In embodiments, the at least one memory and computer program code are configured to, with the at least one processor, cause the apparatus further at least to: when M is greater than or equal to 2, encode additional information over a further portion of the resource grid to indicate position order of the STOP bits in the counter space for the respective M binary strings; and transmit the additional information.

In embodiments, the at least one memory and computer program code are configured to, with the at least one processor, cause the apparatus further at least to: encode the additional information as a binary permutation matrix having M as a first dimension, and M or M−1 as a second dimension.

In embodiments, the at least one memory and computer program code are configured to, with the at least one processor, cause the apparatus further at least to: when the counter values are in one-to-one association with respective resource elements of the counter space, encode the STOP bits over respective resource elements of the counter space by means of non-coherent modulation of sub-carriers of respective resource elements.

In embodiments, the at least one memory and computer program code are configured to, with the at least one processor, cause the apparatus further at least to: when the counter values are in many-to-one association with respective resource elements of the counter space, encode the STOP bits over respective resource elements of the counter space by means of coherent modulation of sub-carriers of respective resource elements.

In embodiments, the predetermined rule comprises assigning increasing counter values to increasing sub-carrier indexes first and next increasing time indexes of the resource grid.

In embodiments, the at least one memory and computer program code are configured to, with the at least one processor, cause the apparatus further at least to: transmit a START bit with the encoded STOP bits, the START bit defining the start of the counter space in the resource grid.

In embodiments, the at least one memory and computer program code are configured to, with the at least one processor, cause the apparatus further at least to: use, when encoding the STOP bits over respective resource elements of the counter space, fractional time shifts.

In embodiments, the at least one memory and computer program code are configured to, with the at least one processor, cause the apparatus further at least to: use, when encoding the STOP bits over respective resource elements of the counter space, fractional frequency shifts.

In embodiments, the at least one memory and computer program code are configured to, with the at least one processor, cause the apparatus further at least to perform repetition coding on the STOP bits.

According to an aspect there is provided an apparatus comprising at least one processor; and at least one memory including computer program code, the at least one memory and computer program code being configured to, with the at least one processor, cause the apparatus at least to: receive STOP bits encoded over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to M binary string values of M binary strings of a predetermined length N, M and N being two non-null positive integers; decode the M binary string values from the received STOP bits; and obtain the M binary strings corresponding to the M decoded binary string values.

In an embodiment, the counter space is a pre-allocated counter space, or configured by the apparatus to a transmitting apparatus via one or more configuration messages, or broadcast or scheduled by the apparatus to the transmitting apparatus for transmission.

In embodiments, the at least one memory and computer program code are configured to, with the at least one processor, cause the apparatus further at least to: when M is greater than or equal to 2, receive additional information over a further portion of the resource grid, the additional information indicating position order of the STOP bits in the counter space for the respective M binary strings; and decode the M binary string values according to the additional information.

In embodiments, the at least one memory and computer program code are configured to, with the at least one processor, cause the apparatus further at least to: receive the additional information encoded as a binary permutation matrix having M as a first dimension, and M or M−1 as a second dimension.

In embodiments, the at least one memory and computer program code are configured to, with the at least one processor, cause the apparatus further at least to: when the counter values are in one-to-one association with respective resource elements of the counter space, decode the received STOP bits by means of non-coherent demodulation of sub-carriers of respective resource elements.

In embodiments, the at least one memory and computer program code are configured to, with the at least one processor, cause the apparatus further at least to: when the counter values are in many-to-one association with respective resource elements of the counter space, decode the received STOP bits by means of coherent demodulation of sub-carriers of respective resource elements.

In embodiments, the predetermined rule comprises assigning increasing counter values to increasing sub-carrier indexes first and next increasing time indexes of the resource grid.

In embodiments, the at least one memory and computer program code are configured to, with the at least one processor, cause the apparatus further at least to: receive a START bit with the STOP bits, the START bit defining the start of the counter space in the resource grid.

In embodiments, the at least one memory and computer program code are configured to, with the at least one processor, cause the apparatus further at least to: broadcast information defining the start of the counter space.

In embodiments, at least one memory and computer program code are configured to, with the at least one processor, cause the apparatus further at least to: use fractional time shifts, when decoding the STOP bits.

In embodiments, the at least one memory and computer program code are configured to, with the at least one processor, cause the apparatus further at least to: use fractional frequency shifts, when decoding the STOP bits.

In embodiments, the at least one memory and computer program code are configured to, with the at least one processor, cause the apparatus further at least to perform repetition decoding on the STOP bits.

According to an aspect there is provided a method comprising: obtaining M binary string values of M binary strings of a predetermined length N, M and N being two non-null positive integers; encoding STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to the M binary string values; and transmitting the encoded STOP bits.

According to an aspect there is provided a method comprising: receiving STOP bits encoded over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to M binary string values of M binary strings of a predetermined length N, M and N being two non-null positive integers; decoding the M binary string values from the received STOP bits; and obtaining the M binary strings corresponding to the M binary string values.

According to an aspect there is provided a computer readable medium comprising instructions which, when executed by an apparatus, cause the apparatus to carry out: obtaining M binary string values of M binary strings of a predetermined length N, M and N being two non-null positive integers; encoding STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to the M binary string values; and transmitting the encoded STOP bits.

In an embodiment, the computer readable medium is a non-transitory computer readable medium.

According to an aspect there is provided a computer program comprising instructions which, when the program is executed by an apparatus, cause the apparatus to carry out: obtaining M binary string values of M binary strings of a predetermined length N, M and N being two non-null positive integers; encoding STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to the M binary string values; and transmitting the encoded STOP bits.

According to an aspect there is provided a signal with embedded data, the signal being encoded with an encoding process which comprises: obtaining M binary string values of M binary strings of a predetermined length N, M and N being two non-null positive integers; encoding STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to the M binary string values.

### BRIEF DESCRIPTION OF DRAWINGS

Embodiments are described below, by way of example only, with reference to the accompanying drawings, in which

FIG. 1 illustrates an exemplified wireless communication system;

FIG. 2 illustrates an example of a counter space;

FIGS. 3 to 6 are flow charts illustrating examples of functionalities;

FIG. 7 illustrates exemplified information exchange;

FIG. 8 illustrates one example use case of the counter space;

FIGS. 9, 10 and 11 show simulation results; and

FIGS. 12 and 13 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first signal could be termed a second signal, and similarly, a second signal could be also termed a first signal without departing from the scope of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultrawideband (UWB) technology, sensor networks, mobile ad-hoc networks (MANETs) and Internet Protocol multimedia subsystems (IMS) or any combination thereof.

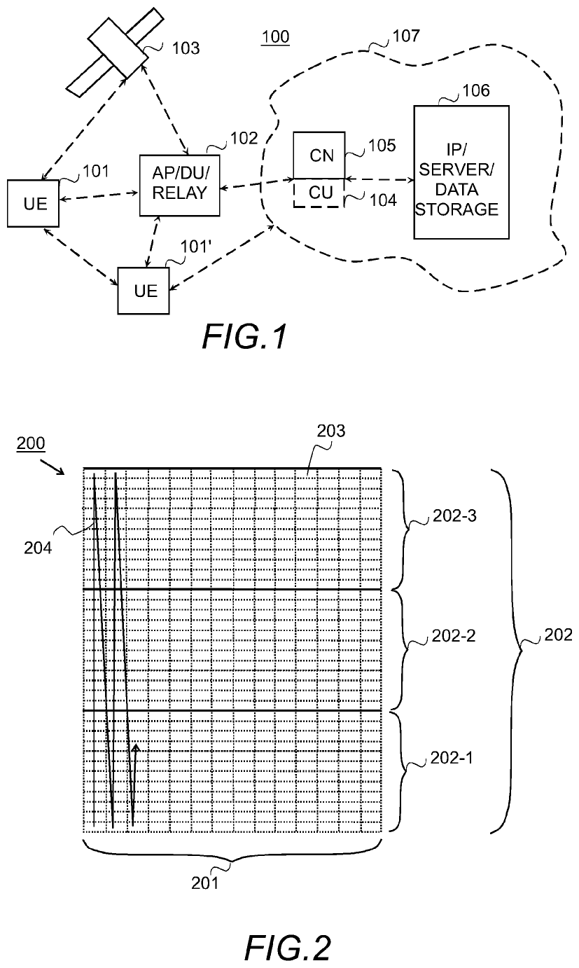

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system 100 given as an example but a person skilled in the art may apply the solution to other communication systems provided with necessary properties.

The example of FIG. 1 shows a part of an exemplifying radio access network.

FIG. 1 shows user devices 101, 101′ configured to be in a wireless connection on one or more communication channels with a node 102. The node 102 is further connected to a core network 105. In one example, the node 102 may be an access node such as (e/g) NodeB providing or serving devices in a cell. In one example, the node 102 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The user device may also utilise cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors micro-controllers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

It is envisaged that in 5G, 6G and beyond there will be use cases requiring medium data rate in addition to use cases categorized into the enhanced mobile broadband (eMBB), ultra-reliable and low latency communication (URLLC), and massive machine-type communication (mMTC). Non-limiting examples of medium data rate use cases include industrial wireless sensor networks, video surveillance, for example for industrial plants and for smart city verticals, and wearables, for example smart watches, wearable medical devices, augmented reality/virtual reality goggles, etc. To increase efficiency of resource usage while providing medium data rate, a counter space and pulse-position modulation principles may be used. The basic idea is to report data to be transmitted in one or more messages as a counter identifier, i.e. a counter value per message, instead of transmitting the message itself. That way, one can transmit with one single ‘STOP’-bit- and potentially one additional counter ‘START’-bit-a message of multiple bits, thereby reducing the required transmit signal power. Different examples are described below using principles and terminology of 5G technology without limiting the examples to 5G.

FIG. 2 illustrates an example of a counter space 200. The counter space 200 is a portion of a resource grid having a predetermined size in the time domain 201 and in the frequency domain 202. Counter values in the counter space 200 are associated with respective resource elements 203 of the counter space according to a predetermined rule 204. Counter values may be associated with one-to-one association (as many counter values as resource elements) or many-to-one association (more counter values than resource elements) with respective resource elements.

A resource element 203 is the smallest physical resource, and in 5G it consists of one subcarrier (frequency domain) during one OFDM (orthogonal frequency-division multiplexing) symbol (time domain). A smallest element of resource allocation is called in 5G a physical resource block. In 5G, the physical resource block is defined as 12 consecutive subcarriers over one OFDM symbol. Hence, the counter space can be defined by one, multiple or all physical resource blocks for a bandwidth or bandwidth part, and a given number of OFDM symbols. For example, one physical resource block spanning over one slot comprising 14 OFDM symbols has 168 resource elements, and for a 20 MHz bandwidth there is 100 physical resource blocks. The thus defined counter space is called below a basic counter space. If the predefined rule associates one counter value to one resource element within the counter space, the basic counter space has 16 800 resource elements and hence 16 800 counter values (counter steps).

In the illustrated example of FIG. 1, the counter space comprises three physical resource blocks 202-1, 202-2, 202-3, i.e. PRB i−1, PRB i and PRB i+1, spanning over one slot comprising 14 OFDM symbols. In the illustrated example, the predetermined rule 204 is to associate counter values to resource elements 203 in the frequency-domain first, over all subcarriers of an OFDM symbol, and then over all subcarriers of a next OFDM symbol, etc. Shortly the predetermined rule 204 may be expressed as the frequency domain first, and the time domain next. Naturally the predefined rule may be to associate counter values to resource elements in the time domain first, over all OFDM symbols of a subcarrier, and next over all OFDM symbols of a next subcarrier, and so forth, i.e. the time domain first, and the frequency domain next.

The counter space may be pre-allocated to the apparatus, for example in factory settings, and/or the wireless network may configure the counter space to the apparatus, for example via radio resource control messaging, and/or the counter space may be scheduled for the apparatus, for example as a part of transmission scheduling in downlink control information. In an implementation, a pre-allocated counter space is in use, unless the wireless network transmits to the apparatus a configuration for the counter-space or schedule the counter-space.

The counter space, or more precisely, the number of counter values within the resource elements in the counter space, may be increased by using bits reserved for a higher modulation order and coherent modulation/demodulation (and corresponding channel estimation), for example by using the bits of a QAM symbol (quadrature amplitude modulation with modulation order occupying 2 bits) or of a 16-QAM symbol (quadrature amplitude modulation with modulation order occupying 4 bits). Assuming that the modulation order is Xn bits, out of which X bits are used for the counter space (X may be equal to or less than Xn), the counter values, and hence the counter space, will increase by a factor X while the number of resource elements in the counter space is not changed. For example, if the modulation order is 4 bits, and all 4 bits are used there will be 67 200 (16 800*4) counter values in the basic counter space, whereas if 3 bits out of 4 bits are used, there will be 50 400 (16 800*3) counter values in the basic counter space.

The counter space may also be increased, while the number of resource elements in the counter space is not changed, by a fractional frequency shift, or by a fractional time shift, or by both the fractional frequency shift and the fractional time shift. (It is possible to use the frequency shift and the time shift simultaneously, since inter carrier interference has a different characteristic for the frequency and the time shifts, thereby enabling the receiving entity to detect the STOP bits.) Assuming that Y fractional time shifts with regard to an OFDM symbol in the time domain are allowed, the counter values, and hence the counter space, will increase by a factor Y. Assuming that Z fractional frequency shifts with regard to a subcarrier in the frequency domain are allowed, the counter values, and hence the counter space, will increase by a factor Z. Assuming that Y fractional time shifts and Z fractional frequency shifts are allowed, a factor will be Y*Z. For example, if fractional time shifts and 5 fractional frequency shifts are allowed, there will be 840 000 (16 800*5*10) counter values in the basic counter space.

It is also possible to increase the counter space, while the number of resource elements in the counter space is not changed, by using the modulation order and by adding fractional frequency shifts and/or fractional time shifts. If the modulation order is 4 bits and if 10 fractional time shifts and 5 fractional frequency shifts are allowed, the factor is 200, and there will be 3 360 000 (16 800*200) counter values in the basic counter space.

Still a further possibility is to increase the counter space, while the number of resource elements in the counter space is not changed, is to use the spatial domain, for example when massive MIMO is used and/or transmissions from various devices are discriminated in the spatial domain, either alone or combined with any of the above ways described. Assuming S spatial layers, the counter values, and hence the counter space, will increase by a factor S, while the number of resource elements does not change. If there are 2 spatial layers, the modulation order is 4 bits and that 10 fractional time shifts and 5 fractional frequency shifts are allowed, the factor is 400, and there will be 6 720 000 (16 800*400) counter values in the basic counter space. If there are 2 spatial layers, but no other ways to increase is used, the factor is 2 and there will be 33 600 (16800*2) counter values in the basic counter space.

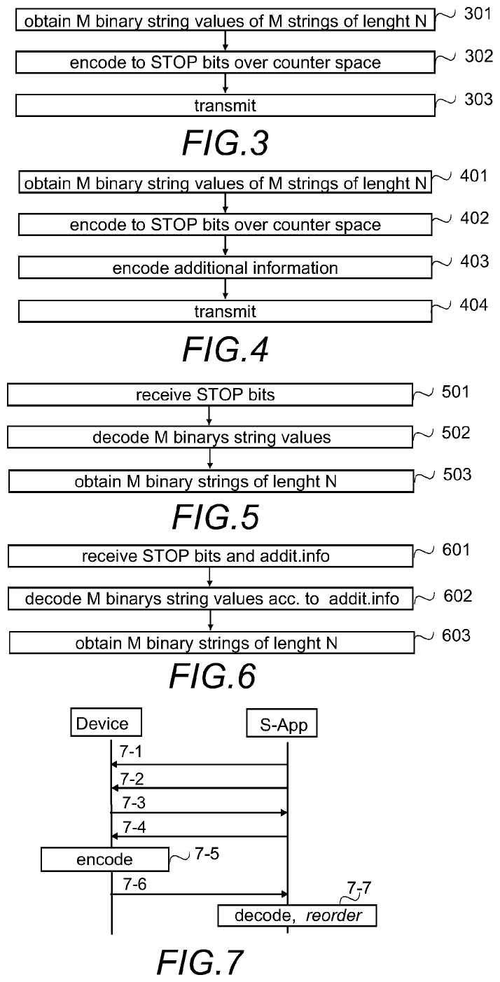

FIG. 3 discloses an example how the counter space with a plurality of counter values may be used for transmitting data.

Referring to FIG. 3, M binary string values of M binary strings of a predetermined length N are obtained in block 301 from the data. M and N are two non-null positive integers, which may have the same value or a different value. For example, both M and N may be 5 or 10 or 20, or M may be 10 and N may be 5, just to give some non-limiting examples. In other words, the data to be transmitted will be split to consecutive M binary strings (bit strings) b=[b₁ . . . bᵢ . . . b_{N}] of the predetermined length N, and corresponding binary values are calculated. The binary value of a binary string is Σᵢ₌₁^{N}2ⁱ⁻¹bᵢ, and a maximum counter length (counter values used) is 2N for the M values.

Then STOP bits are encoded in block 302 over respective resource elements of the counter space, the counter values of the respective resource elements over which the STOP bits are encoded corresponding to the M binary string values, and the encoded STOP bits are transmitted in block 303. In other words, a binary string having a binary string value Σᵢ₌₁^{N}2ⁱ⁻¹bᵢ is encoded to a resource element associated with a counter value c=Σᵢ₌₁^{N}2ⁱ⁻¹bᵢ. In implementations using a predefined start point of the counter, the STOP bits may be encoded without any START bit being encoded. In another implementation, START bits are encoded relative to the STOP bits. Still further possibilities include encoding one START bit with the STOP bits, at least when the predefined start point is not used, and encode the STOP bits in sequential order so that there will be per a STOP bit the maximum counter length, for example 2^{N}, and the combined counter length will be M times the maximum counter length. In a slightly modified version a variable counter length is used, wherein a STOP bit is also a START bit for the next counter value.

FIG. 4 discloses another example how the counter space with a plurality of counter values may be used for transmitting data by allowing multiple STOP bits to be transmitted within one counter length, which is based on the predetermined length of binary strings, i.e. based on 2^{N}. In other words, when M is greater than or equal to 2, it is possible to encode and transmit multiple STOP bits within one counter length. Below this is called multiple parallel STOP bits concept.

Referring to FIG. 4, M binary string values of M binary strings of a predetermined length N are obtained in block 401 from data to be transmitted, as described above with FIG. 3. Then the STOP bits are encoded in block 402 over respective resource elements within the counter length with an increasing order of the stop bits. To indicate to the receiving side position order of the STOP bits in the counter space corresponding to the M binary strings, additional information is encoded in block 403 over a further portion of the resource grid. In other words, the additional information indicates the position order of the STOP bits in the counter space for the respective binary strings, for instance the 2^{nd} binary string corresponds to the STOP bit having the 1ₛₜ position order in the counter space, and the 1ₛₜ binary string corresponds to the STOP bit having the 4th position order in the counter space, and so forth. The additional information may be a bitmap or a permutation matrix. The permutation matrix may be dimensioned as M× M, M−1× M, or M× M−1 matrix, comprising M or M−1 non-zero bits, a non-zero bit indicating the position order of the STOP bit in the counter space for the respective binary string. (Permutation matrix having M−1 as one of the dimensions is an adapted permutation matrix.) Depending on an implementation, the M columns of the permutation matrix or the M rows of the permutation matrix are used as a basis to indicate the position orders of the STOP bits in the counter space for the respective M binary strings. It is possible to use M−1 row or columns to indicate the position orders of the STOP bits in the counter space for the respective M−1 binary strings, since when the position order of the STOP bits for the respective M−1 binary strings is known, the position order of the STOP bit for the one so far missing binary string can be derived. The additional information also ensures precision in case two or more binary strings have the same binary value, resulting that one STOP bit is encoded, since the additional information refers to the same STOP bit (same STOP bit position) as many times as there are binary strings having the same binary string value. In other words, M binary string values are encoded to S STOP bits, wherein S is an integer that is equal to or less than M, and the additional information indicates how many times and in which order one STOP bit is to be decoded. For example, assuming that additional information is a permutation matrix using columns to convey the position order, M is 5, 2^{nd} and 3^{rd} binary strings have the same binary string value meaning that their STOP bits have the same value corresponding to the 4th STOP bit position in the counter space, then 4 STOP bits are encoded (instead of 5), and in the permutation matrix the 2^{nd} and 3^{rd} columns will be set to the same value ‘00010’. (The result is then a permutation matrix that will have M bits, a bit per column, but there will be one row without any bit and a row with two bits, so even when both dimensions are M, the resulting permutation matrix is an adapted permutation matrix.)

Then the encoded STOP bits and the additional information are transmitted in block 404, for example as one go, or the encoded STOP bits are transmitted first and then the additional information is transmitted, or vice versa. It should be appreciated that the encoded STOP bits may be transmitted while the additional information is encoded.

Assuming that M and N are 10, and the bitmap uses 4 bits for N=M=10, the additional information results in transmission of 40 bits. Assuming that M and N are 10, and a permutation matrix 10×10 is used, the additional information results in transmission of 10 non-zero bits. As can be seen from the examples, compared to the bitmap, the number of non-zero bits to be transmitted when the permutation matrix is used, is much lower.

FIG. 5 illustrates an example how the how the counter space with a plurality of counter values may be used for receiving data transmitted using the examples described with FIG. 3.

Referring to FIG. 5, when transmission comprising STOP bits encoded is received in block 501, the STOP bits received are decoded in block 502 to M binary string values using respective resource elements of the counter space, and M binary strings of the predetermined length N corresponding to the M binary string values are obtained in block 503. For example, an encoded STOP bit received in a resource element indicates a counter value, which corresponds to a binary string value Σᵢ₌₁^{N}2ⁱ⁻¹bᵢ, which is a binary string value of a binary string b=[b₁ . . . bᵢ . . . b_{N}]. The data transmitted, for example a data message transmitted, is reconstructed by combining the binary strings.

FIG. 6 illustrates an example how in the multiple parallel STOP bits concept the counter space with a plurality of counter values may be used for receiving data transmitted.

Referring to FIG. 6, when transmission comprises encoded STOP bits, and the additional information are received in block 601, the STOP bits received in respective resource elements of a counter space are decoded in block 602 to M binary string values according to the additional information, i.e. to be according to position order indicated by the additional information. M bit strings of the predetermined length N corresponding to the M binary string values are obtained in block 603. Hence, the M bit strings may be combined to reconstruct the data that was transmitted. It should be appreciated that in another implementation, the M binary strings are obtained and then reordered according to the additional information to reconstruct the data that was transmitted.

FIG. 7 illustrates a non-limiting example of information exchange that can be used for the above described processes and their further variations. In the illustrated example a device is used as an example of a transmitting entity (apparatus) and a serving apparatus, S-App, in a wireless network, as an example of a receiving entity. The serving apparatus may be an access node, such as a base station, examples of which are given above, or a transmission-reception point.

Referring to FIG. 7 the serving apparatus configures (message 7-1), for example using radio resource control signaling, the device to use STOP bits encoded over a counter space for data transmission, and further transmits one or more parameters (message 7-2), for example using the radio resource signaling. The parameters may comprise parameter values, or corresponding indications, for one or more of the following:
M, i.e. number of binary strings to transmit in a counter-space;
N, i.e. length of the binary string;
one or more counterspace definitions in the frequency domain and in the time domain, for example number of physical resource blocks and number of OFDM symbols
rule to associate counter values to resource elements;
modulation type (coherent/non-coherent), modulation order (m), and/or how many/which bits of the modulation symbols are used;
rules for collision;
repetition coding scheme;
fractional time shift;
fractional frequency shift; and
whether to use a START bit to define the start of the counter space.

For example, by varying values of N and M, the number of STOP bits transmitted over the number of resource elements in the counter space can be optimized in view of different criteria, like minimum latency, best resource usage, minimum relative overhead for the additional information, etc. The values also affect the resource usage. For example, assuming one-to-one association in the multiple parallel STOP bit concept, with N and M being 10, ten STOP bits can be transmitted over 1024 resource elements, one bit conveying information on 10 bits in the data, with N and M being 20, twenty STOP bits can be transmitted over 1048576 resource elements, one bit conveying information on 20 bits in the data. Hence, a larger value leads to a larger counting delay and to a lower resource usage, but at the same time to a better compression gain. (If no START bits are transmitted, a lossless compression ratio is 1/N.)

To encode STOP bits over respective resource elements of the counter space by means of modulation of sub-carriers of respective resource elements, a modulation type may be given. The modulation type may be a coherent modulation, for example BPSK (binary phase shift keying), or QAM (quadrature amplitude modulation), or 16-QAM, when counter values are in many-to-one association with respective resource elements of the counter space. The modulation may be a non-coherent modulation, when counter values are in one-to-one association with respective resource elements of the counter space, wherein it is sufficient to perform mere energy/power detection per resource element to detect the STOP bits.

In the multiple parallel STOP bit concept, one or more rules for collision, i.e. when there are two or more binary strings having the same binary string value resulting to one STOP bit, may be transmitted. For example, for the additional information, parameters indicating whether to use bitmap or permutation matrix, or dimensions of the permutation matrix and whether columns or rows are used to indicate the position order, may be given as parameters. Further possibilities to provide the alternative information include a use of power or a “counter value manipulation rule”. For example, a collision rule may indicate to use a “power rule”, in which a power of a STOP bit depends on how many binary string values nₛₜₒₚ are encoded to the STOP bit. For example, the power rule may be C*power, wherein C is the number of binary strings having the same binary string value resulting to one STOP bit, thereby increasing the power when there are colliding binary string values (colliding counter values). An example of the counter manipulation rule is to increase a STOP bit counter value per a colliding binary string value. For example, if there are two colliding binary strings with binary string value nₛₜₒₚ, then a STOP bit for the first bit string is transmitted at counter value c=nₛₜₒₚ, and for the next bit string having the binary string value, a counter value is increased by one relative to stop and the STOP bit is transmitted at counter value c=nₛₜₒₚ+1. This rule increases the overall counter length to be 2^{N}+N.

Another kind of collision is to have consecutive binary string values/counter values. A collision rule to avoid having consecutive STOP bits is to add frequency offset and/or time offset around every second consecutive counter value. For example, five sub-carrier offsets and/or one time offset may be added. the “consecutive counter value rule” may also be part of the rule to associate counter values to resource elements.

For coverage enhancement, one might include repetition coding of STOP bits, as known for conventional data transmissions. The repetition coding scheme may comprise a value R, which is a non-null integer, and defines how many times a STOP bit is repeated. Further, the repetition coding scheme parameters may define a set of relative resource elements for repetitions of the STOP bit. The set may be R consecutive resource elements, or the set may be R resource elements distributed in a predefined manner. The repetition coding, when R is bigger than one, enhances coverage and supports low quality radio connections, for examples connections with very low signal to interference noise ratio, due to the fact that the more often the STOP bit is repeated, the higher the likelihood that the STOP bit is decoded correctly.

A parameter value for a fractional time shift may indicate how many fractional time shifts are allowed. Further, there may be a parameter value indicating whether a guard interval or cyclic prefix of an OFDM symbol is used or not. If no cyclic prefix is used and transmitted, resource usage is improved by about 10%. The parameter value indicating use/non-use of a guard interval or cyclic prefix may be a parameter value or a rule defining a minimum relative distance between STOP bits, to avoid a very rare situation of two adjacent OFDM symbols carrying STOP bits.

A parameter value for a fractional time shift may indicate how many fractional frequency shifts are allowed.

A parameter value for the start of the counter space may indicate whether to add one START bit, or one START bit per one STOP bit, or not to add a START bit. Still further possibilities include that the parameter value indicates that STOP bit is also a START bit when variable counter length is used. The parameter value for the START bit may also define the start of the counter space.

Returning back to FIG. 7, when there is data to be transmitted, the device sends in the illustrated example an uplink grant request (message 7-3) and receives the uplink grant (message 7-4).

Then the device encodes the data in block 7-5, using the parameter settings and the predefined rule to calculate counter values, and then transmit (message 7-6) at least the STOP bits over the respective resource elements. When the parallel multiple STOP bits concept is used, additional data is also encoded in block 7-5, and transmitted.

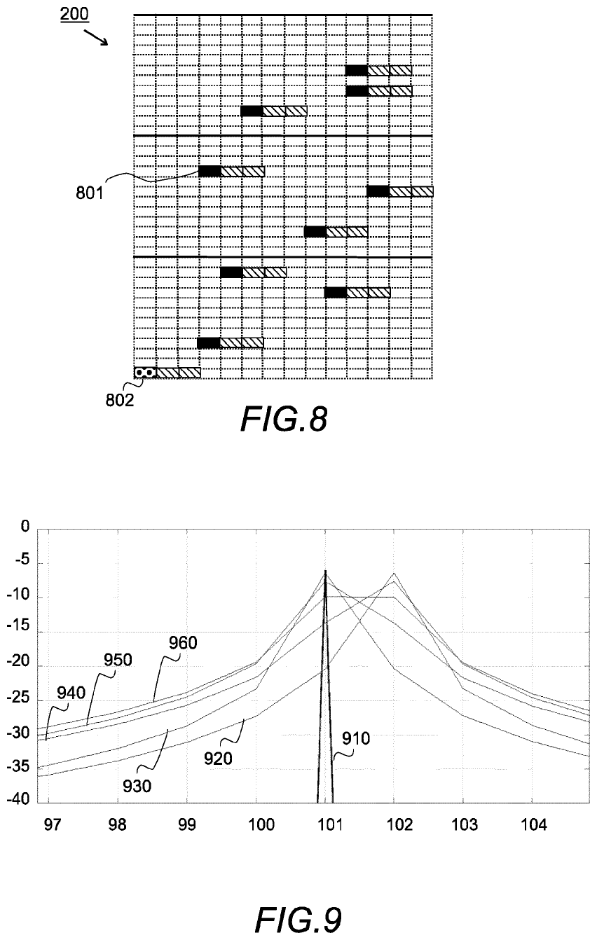

FIG. 8 illustrates a highly simplified example of a transmission when repetition coding scheme is 3 consecutive resource elements, no fractional time shifts and frequency shifts are allowed, and one START bit is to be inserted using the counter space 200 of FIG. 2. Referring to FIG. 8, there are nine sets 801 of STOP bits 801, partly black, partly hatched, the black portion of the set 801 illustrating what would be transmitted without the repetition, and one set 802 of START bits, partly dotted, partly hatched, the dotted portion illustrating what would be transmitted without the repetition.

Using the examples given with FIG. 2 on different counter values, and value 10 for M and N, and transmission time interval of one millisecond, following transmission rates can be reached:
when the counter space comprises 16 800 counter values, 16 parallel counters with counter lengths of 1024 can be used, transmission bit rate may be 1.6 Mbit/s;
when the counter space comprises 67 200counter values, 65 parallel counters with counter lengths of 1024 can be used, transmission bit rate may be 6.5 Mbit/s, which may be high enough bit rate for reduced capability devices introduced in 5G;

In another example, using the basic counter space, assuming that spectral efficiency per resource element RE is 3 bit/s/Hz (i.e. signal to interference noise ratio is better than 10 dB), having N=11 (counter length 2048) and M=45, permutation matrix of size 45*45 (2025 bits) is used, the number of allowed frequency shifts is 4 and the number of allowed time shifts is 10, and transmission time interval of one millisecond, a throughput is 400 Mbit/s (=16800*3*4*10*1000/((2048+2025)*11*45). In massive MIMO and joint transmission coordinated multi-point operation the device reports channel information, for example by means of a channel state indicator, for a high number of frequency selective radio channel components, with suitable parameters values for N, M, frequency shift and time shift, a further compression gain for overhead reporting can be achieved. For example, (compressed) channel state indicators may be combined into one message, which is then split to M binary strings of length N, as many times as required or allowed by the counter value of the counter space for counter length 2N.

Returning back to FIG. 7, when the serving apparatus receives message 7-6, it detects the STOP bits and in block 7-7 decodes (including demodulation), and possibly reorders, the STOP bits to M binary string values and then to M binary strings and reconstructs the data, using the same parameters for the counter space as the transmitting device.

If the transmission is the one illustrated with FIG. 8, the receiving apparatus may be configured to receive the transmission in block 7-7 as follows: the receiving apparatus detects a first resource element having a reception power above a first threshold value, and then combines its reception power to reception power of next two resource elements, and if the combined power is above a second threshold value, the serving apparatus determined that a STOP bit is received in the first resource element. In a more robust implementation, a STOP bit may be determined to be received in the first resource element if at least K out of R resource elements where the STOP bit should be detectable, is above a third threshold. For example, K may be 2 when R is 3, or K may be 5 when R is 10. The third threshold may be the same or higher than the first threshold.

Using any of the above described solutions, or their combinations, it is possible to reduce transmission signal power, due to the fact that the number of transmitted bits is much smaller compared to the number of bits in the reported data. For example, with almost zero power devices this may be used to increase discontinuous reception sleep time, which saves battery power.

The sparce structure of the transmissions make it possible to achieve a lower peak to average power ratio compared to transmissions not using the STOP bits as described above. This enables a more efficient use of power amplifiers with a lower power backoff.

Further, it is possible to schedule (allocate), when channel state estimation is performed, for example by using channel state indicators, resources corresponding to the counter space on physical resource blocks that have high signal-to-interference ratio. It is also possible to use a more robust and simple scheme in which conventional MIMO spatial diversity methods are applied to generate an almost flat radio channel, which avoids the need for physical resource block specific scheduling for the counter space, i.e. for transmissions using the STOP bits.

FIGS. 9 to 11 show different simulation results relating to the fractional frequency and/or time shifts at the receiving entity.

FIG. 9 shows simulation results indicating inter carrier interference for different fractional frequency shifts The x axis indicates subcarrier frequencies and the y axis reception powers in dB. The simulation was performed assuming a basic subcarrier frequency 101, and five fractional frequency shifts Δf=i/(5 f_{SC}); i=1 . . . 5 with f_{SC} as a spacing between the used subcarriers encoding the STOP bits. For 5G FR1, i.e. a frequency band from 410 MHz to 7125 MHz, the spacing between the used subcarriers encoding the STOP bits is 90 KHz. More precisely, assuming 15 kHz subcarrier spacing, 12 subcarriers equals to 180 kHz (=12*15 kHz), 5 sub-carriers are left unused on each side of the basic subcarrier frequency 101, used subcarriers are 90 kHz apart from each other with 5 subcarriers left unused in between.

As can be seen from FIG. 9, a signal 910 without frequency shift is without any inter carrier interference, while signals 920, 930, 940, 950 and 960 with frequency shifts generate characteristic inter subcarrier interference.

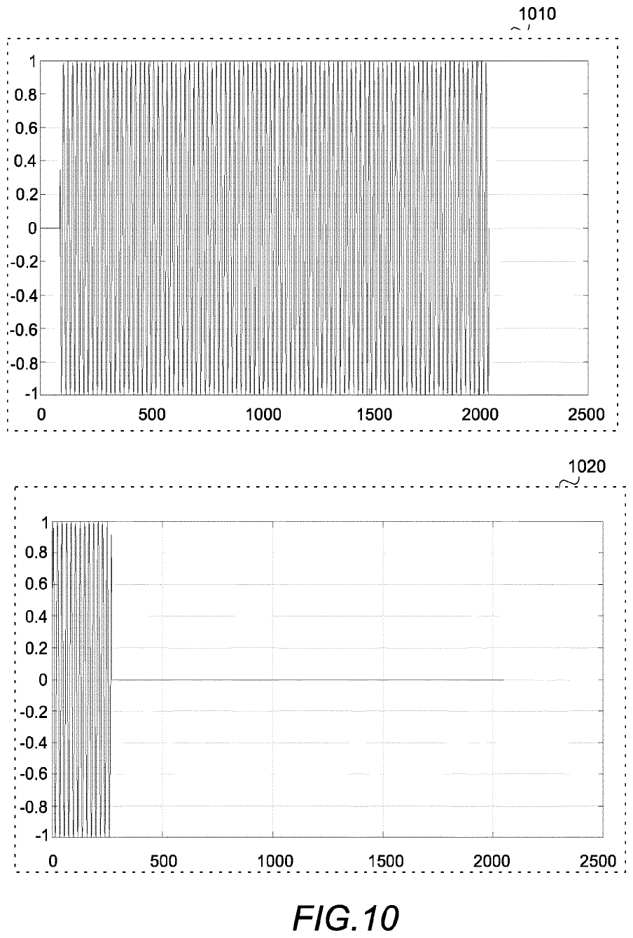

FIG. 10 shows simulation results indicating partial time shift effect on two consecutive OFDM symbols with a basic subcarrier frequency 100, when cyclic prefixes are not used, and the time shift is 270 time samples out of 2048 time slots relative to no time shift (zero time shift). It is a time shift of more than one us. The x axis indicates time samples and the y axis reception powers in dB.

Referring to FIG. 10, in the first OFDM symbol 1010 first 270 zero samples are obtained, and in the second OFDM symbol 1020 the inter symbol interference is obtained as the first 270 non zero samples.

A signal simulated in FIG. 10 generates beside the time domain inter symbol interference also interference in the frequency domain, illustrated by simulation results shown in Figure. The x axis indicates subcarrier frequencies and the y axis reception powers in dB.

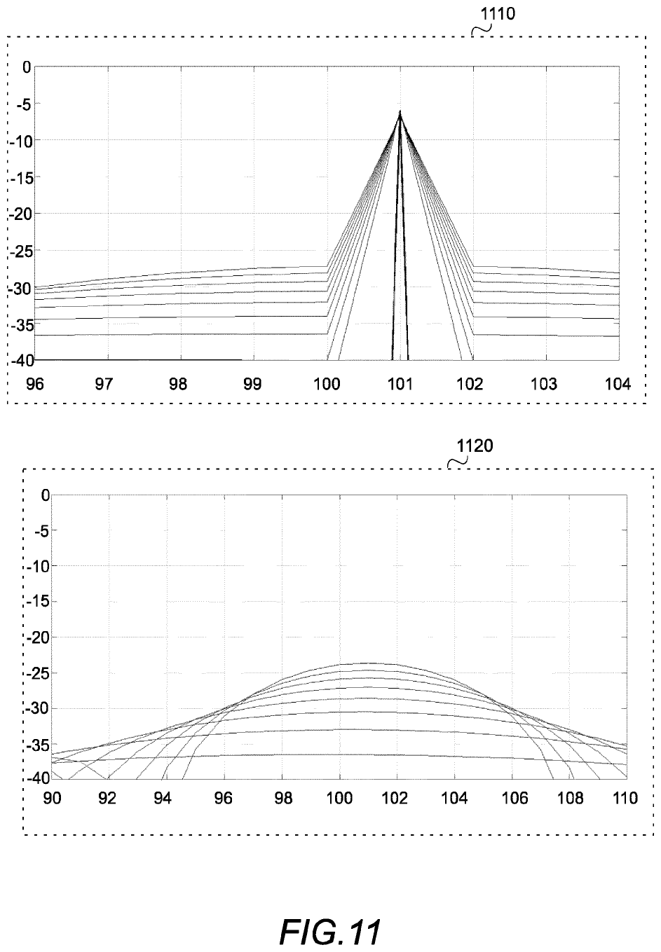

As can be seen from FIG. 11, a characteristic spectrum depends on a time shift applied to a STOP bit. In the simulation example shown in FIG. 11, there are ten different time shifts with 30 times 33 ns resulting to 1 us per time shift and 10 us for the largest time shift. The inter carrier interference affects then up to plus minus five subcarriers and the related interference for the first OFDM symbol 1110 as well as for the second OFDM symbol 1120 is about −16 to −20 dB.

Even though there may be strong inter symbol and inter carrier interferences, which would cause degradation in transmissions not using STOP bits, However, when using STOP bits, as described above, the interferences can be overlooked: the receiving entity will detect the related inter carrier interference structures to estimate the transmitted time delay as well as frequency offsets and determine corresponding counter values.

The blocks, related functions, and information exchanges described above by means of FIGS. 2 to 11 are in no absolute chronological order, and some of them may be performed simultaneously or in an order differing from the given one. Other functions can also be executed between them or within them, and other information may be transmitted. Some of the blocks or part of the blocks or one or more pieces of information can also be left out or replaced by a corresponding block or part of the block or one or more pieces of information. Further, the different implementations described for a block may be freely combined with any of different implementations of another block.

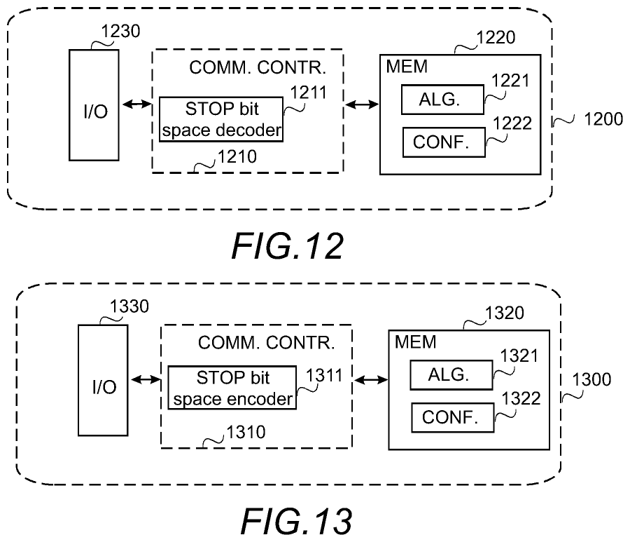

FIGS. 12 and 13 illustrate apparatuses comprising a communication controller 1210, 1310 such as at least one processor or processing circuitry, and at least one memory 1220, 1320 including a computer program code (software, algorithm) ALG. 1221, 1321, wherein the at least one memory and the computer program code (software, algorithm) are configured, with the at least one processor, to cause the respective apparatus to carry out any one of the embodiments, examples and implementations described above. FIG. 12 illustrates an apparatus, for example a base station or an access node or a transmission reception point, or a decoder, which may be a separate apparatus or comprised in an apparatus, or any corresponding receiving entity, configured at least to receive STOP bits and decode them to binary strings. FIG. 13 illustrates an apparatus, for example a sensor or a reduced capability device, such as a user equipment, or terminal device in a vehicle, or any transmitting entity, to perform encoding binary strings to STOP bits and transmitting the STOP bits, for example as possibly indicated by apparatus of FIG. 12. The apparatuses of FIGS. 12 and 13 may be electronic devices, examples being listed above with FIGS. 1 and 2. Further, it should be appreciated that the apparatuses of FIGS. 12 and 13 may be integrated to be one apparatus, configured to act both as a receiving entity and transmitting entity, using STOP bits and counter space.

Referring to FIGS. 12 and 13, the memory 1220, 1320 may be implemented using any suitable data storage technology, such as semiconductor based memory devices, flash memory, magnetic memory devices and systems, optical memory devices and systems, fixed memory and removable memory. The memory may comprise a configuration storage CONF. 1221, 1321, such as a configuration database, for example for storing counter space parameters. The memory 1220, 1320 may further store other data, such as a data buffer for data waiting to be processed.

Referring to FIG. 12, the apparatus comprises a communication interface 1230 comprising hardware and/or software for realizing communication connectivity according to one or more wireless and/or wired communication protocols. The communication interface 1230 may provide the apparatus with radio communication capabilities with different apparatuses, for example with the apparatus of FIG. 13, as well as communication capabilities towards core network.

Digital signal processing regarding transmission and reception of signals may be performed in a communication controller 1210. The communication interface may comprise standard well-known components such as an amplifier, filter, frequency-converter, (de) modulator, and encoder/decoder circuitries and, in case wireless communication is supported, one or more antennas.

The communication controller 1210 comprises a STOP bit decoding circuitry 1211 (STOP bit space decoder) configured to receive and decode STOP bits, according to any one of the embodiments/examples/implementations described above. The STOP bit decoding circuitry 1211 may further be configured to configure a transmitting entity for the STOP bit transmissions, or otherwise transmit parameters, as described above. The communication controller 1210 may control the the STOP bit decoding circuitry 1211.

In an embodiment, at least some of the functionalities of the apparatus of FIG. 12 may be shared between two physically separate apparatuses, forming one operational entity. Therefore, the apparatus may be seen to depict the operational entity comprising one or more physically separate apparatuses for executing at least some of the processes described with an apparatus configured at least to receive STOP bit transmissions.

Referring to FIG. 13, the apparatus 1300 may further comprise a communication interface 1330 comprising hardware and/or software for realizing communication connectivity according to one or more wireless communication protocols. The communication interface 1330 may provide the apparatus 1300 with communication capabilities with the apparatus of FIG. 12, for example. The communication interface may comprise standard well-known analog components such as an amplifier, filter, frequency-converter and circuitries, conversion circuitries transforming signals between analog and digital domains, and one or more antennas. Digital signal processing regarding transmission and reception of signals may be performed in a communication controller 1310.

The communication controller 1310 comprises a STOP bit encoding circuitry 1311 (STOP bit space encoder) configured to encode binary strings to STOP bits according to any one of the embodiments/examples/implementations described above. The communication controller 1310 may control the STOP bit encoding circuitry 1311.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 11 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 11, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g, procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the apparatuses described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 11 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising
at least one processor; and
at least one memory including computer program code, the at least one memory and computer program code being configured to, with the at least one processor, cause the apparatus at least to:
obtain M binary string values of M binary strings of a predetermined length N, M and N being two non-null positive integers;
encode STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the re-source elements over which the STOP bits are encoded correspond to the M binary string values; and
transmit the encoded STOP bits.

2. The apparatus of claim 1, wherein the counter space is pre-allocated to the apparatus, or configured to the apparatus via one or more configuration messages, or broadcast or scheduled for the apparatus for transmission.

3. The apparatus of claim 1, wherein the at least one memory and computer program code are configured to, with the at least one processor, cause the apparatus further at least to:
when M is greater than or equal to 2, encode additional information over a further portion of the resource grid to indicate position order of the STOP bits in the counter space for the respective M binary strings; and
transmit the additional information.

4. The apparatus of claim 3, wherein the at least one memory and computer program code are configured to, with the at least one processor, cause the apparatus further at least to:
encode the additional information as a binary permutation matrix having M as a first dimension, and M or M−1 as a second dimension.

5. The apparatus of claim 1, wherein the at least one memory and computer program code are configured to, with the at least one processor, cause the apparatus further at least to:
when the counter values are in one-to-one association with respective resource elements of the counter space, encode the STOP bits over respective resource elements of the counter space by means of non-coherent modulation of sub-carriers of respective resource elements.

6. The apparatus of claim 1, wherein the at least one memory and computer program code are configured to, with the at least one processor, cause the apparatus further at least to:
when the counter values are in many-to-one association with respective resource elements of the counter space, encode the STOP bits over respective resource elements of the counter space by means of coherent modulation of sub-carriers of respective resource elements.

7. The apparatus of claim 1, wherein the predetermined rule comprises assigning increasing counter values to increasing sub-carrier indexes first and next increasing time indexes of the resource grid.

8. The apparatus of claim 1, wherein the at least one memory and computer program code are configured to, with the at least one processor, cause the apparatus further at least to:
transmit a START bit with the encoded STOP bits, the START bit de-fining the start of the counter space in the resource grid.

9. The apparatus of claim 1, wherein the at least one memory and computer program code are configured to, with the at least one processor, cause the apparatus further at least to:
use, when encoding the STOP bits over respective resource elements of the counter space, fractional time shifts.

10. The apparatus of claim 1, wherein the at least one memory and computer program code are configured to, with the at least one processor, cause the apparatus further at least to:
use, when encoding the STOP bits over respective resource elements of the counter space, fractional frequency shifts.

11. The apparatus of claim 1, wherein the at least one memory and computer program code are configured to, with the at least one processor, cause the apparatus further at least to perform repetition coding on the STOP bits.

12. An apparatus comprising
at least one processor; and
at least one memory including computer program code, the at least one memory and computer program code being configured to, with the at least one processor, cause the apparatus at least to:
receive STOP bits encoded over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the resource elements over which the STOP bits are encoded correspond to M binary string values of M binary strings of a predetermined length N, M and N being two non-null positive integers;
decode the M binary string values from the received STOP bits; and
obtain the M binary strings corresponding to the M decoded binary string values.

13. (canceled)

14. The apparatus of claim 12, wherein the at least one memory and computer program code are configured to, with the at least one processor, cause the apparatus further at least to:
when M is greater than or equal to 2, receive additional information over a further portion of the resource grid, the additional information indicating position order of the STOP bits in the counter space for the respective M binary strings; and
decode the M binary string values according to the additional information.

15. The apparatus of claim 14, wherein the at least one memory and computer program code are configured to, with the at least one processor, cause the apparatus further at least to:
receive the additional information encoded as a binary permutation matrix having M as a first dimension, and M or M−1 as a second dimension.

16. The apparatus of claim 12, wherein the at least one memory and computer program code are configured to, with the at least one processor, cause the apparatus further at least to:
when the counter values are in one-to-one association with respective resource elements of the counter space, decode the received STOP bits by means of non-coherent demodulation of sub-carriers of respective resource elements.

17. The apparatus of claim 12, wherein the at least one memory and computer program code are configured to, with the at least one processor, cause the apparatus further at least to:
when the counter values are in many-to-one association with respective resource elements of the counter space, decode the received STOP bits by means of coherent demodulation of sub-carriers of respective resource elements.

18. The apparatus of claim 12, wherein the pre-determined rule comprises assigning increasing counter values to increasing sub-carrier indexes first and next increasing time indexes of the resource grid.

19. The apparatus of claim 12, wherein the at least one memory and computer program code are configured to, with the at least one processor, cause the apparatus further at least to:
receive a START bit with the STOP bits, the START bit defining the start of the counter space in the resource grid.

20. The apparatus of claim 12, wherein the at least one memory and computer program code are configured to, with the at least one processor, cause the apparatus further at least to:
broadcast information defining the start of the counter space.

21-23. (canceled)

24. A method comprising:
obtaining M binary string values of M binary strings of a predetermined length N, M and N being two non-null positive integers;
encoding STOP bits over respective resource elements of a counter space, wherein the counter space is a portion of a resource grid having a predetermined size in the time domain and in the frequency domain, wherein counter values are associated with respective resource elements of the counter space according to a predetermined rule, and wherein the counter values of the re-source elements over which the STOP bits are encoded correspond to the M binary string values; and
transmitting the encoded STOP bits.

25-29. (canceled)
